(19) United States
(12) Patent Application Publication
(10) Pub. No.: US 2019/0276143 A1
(43) Pub. Date: Sep. 12, 2019

(54) BLADE RETENTION SYSTEM FOR RIGID ROTOR

(71) Applicant: Sikorsky Aircraft Corporation, Stratford, CT (US)

(72) Inventors: Frederick J. Miner, Barkhamsted, CT (US); Rodger W. Bowman, Derby, CT (US); Stephen V. Poulin, Milford, CT (US); Erik M. Byrne, New Haven, CT (US); Devon K. Cowles, Bridgewater, CT (US); Richard Thomas Hood, Fairfield, CT (US)

(21) Appl. No.: 15/918,794

(22) Filed: Mar. 12, 2018

(51) Int. Cl. B64C 27/48; B64C 27/82; B64C 27/10

(52) U.S. Cl. CPC B64C 27/48; B64C 27/10; B64C 27/82

(57) ABSTRACT

A blade retention system includes a rotor hub including a plurality of radial arms, and a blade retention yoke associated with the rotor hub and one of the plurality of radial arms. The blade retention yoke is rotatable relative to the rotor hub and the radial arm. A tension torsion device connects the radial arm to the blade retention yoke to restrict radial movement of the blade retention yoke relative to the radial arm.

### STATEMENT OF FEDERAL SUPPORT

This invention was made with government support under Agreement No. W911W6-13-2-0003 for the Joint Multi-Role Technology Demonstrator Phase I-Air Vehicle Development program. The Government has certain rights in the invention.

### BACKGROUND

Embodiments of the disclosure relate generally to a rotor blade system of a rotary wing aircraft, and more specifically, to a blade retention system for coupling a rotor blade of a rotary wing aircraft to a rotor hub.

Rotor systems for rotary-wing aircraft, such as helicopters and tilt rotor aircraft for example, are relatively complex systems. The rotor system not only needs to respond to the pilot's input, but also needs to accommodate forces acting upon the rotor system which may be generally outside of direct pilot control.

In aerospace applications it is beneficial to reduce the weight of an aircraft. At the same time, the integrity of the aircraft or the aircraft structure needs to be maintained. In this respect, a light-weight rotor system is needed. A reduction in drag associated with the rotor system or rotor blades relative to conventional designs would also improve efficiency of the aircraft. In conventional rotor designs, loads imposed upon the rotor or rotor blades may serve to degrade the reliability and maintainability of the rotor. Improvements are needed over conventional rotor designs in terms of the handling of such loads in order to enhance the performance and sustainability of die rotor.

### BRIEF DESCRIPTION

According to an embodiment, a blade retention system includes a rotor hub including a plurality of radial arms, and a blade retention yoke associated with the rotor hub and one of the plurality of radial arms. The blade retention yoke is rotatable relative to the rotor hub and the radial arm. A tension torsion device connects the radial arm to the blade retention yoke to restrict radial movement of the blade retention yoke relative to the radial arm.

In addition to one or more of the features described above, or as an alternative, in further embodiments the blade retention yoke is rotatable relative to the rotor hub and the radial arm via at least one bearing.

In addition to one or more of the features described above, or as an alternative, in further embodiments the blade retention yoke includes an inner blade retention component and an outer blade retention component, the inner blade retention component being connected to the rotor hub via a first bearing and the outer blade retention component being connected to the radial arm via a second bearing.

In addition to one or more of the features described above, or as an alternative, in further embodiments the blade retention yoke is mountable to a rotor blade, and the first bearing and the second bearing are configured to accommodate span-wise and chord-wise forces acting on the rotor blade which allow rotation about a pitch axis of the rotor blade.

In addition to one or more of the features described above, or as an alternative, in further embodiment the tension torsion device, and not the first bearing or second bearing, supports the centrifugal forces acting on the rotor blade which is substantially parallel to the pitch axis.

In addition to one or more of the features described above, or as an alternative, in further embodiments the radial arm includes a shaft-like protrusion connectable to the second bearing and the inner blade retention component includes a shaft-like protrusion connectable to the first bearing.

In addition to one or more of the features described above, or as an alternative, in further embodiments at least one of the shaft-like protrusion of the radial arm and the shaft-like protrusion of the inner blade retention component has a sleeve concentrically mounted thereto.

In addition to one or more of the features described above, or as an alternative, in further embodiments the sleeve includes a low friction material such that the sleeve is slidable relative to the first bearing and/or second bearing.

In addition to one or more of the features described above, or as an alternative, in further embodiments the sleeve includes at least one featured receivable within a corresponding opening formed in the first bearing or second bearing to rotatably couple the shaft-like protrusion to the first bearing and/or second bearing.

In addition to one or more of the features described above, or as an alternative, in further embodiments the sleeve defines an inner race of the first bearing and/or second bearing.

In addition to one or more of the features described above, or as an alternative, in further embodiments at least one of the first bearing and the second bearing further includes: an inner race, an outer race, a plurality of rolling elements positioned between the inner race and the outer race having a spherical outer diameter, and a bearing liner positioned between the outer race and the outer blade retention component. The plurality of rolling elements is centered about a center of the bearing liner.

According to another embodiment, a rotor system includes a rotor hub including at least one radial arm, at least one rotor blade, at least one blade retention yoke connecting the at least one rotor blade to the rotor hub and the at least one radial arm, a first bearing mounted at an interface between the blade retention yoke and the rotor hub, and a second bearing mounted at an interface between the blade retention yoke and the radial arm. The blade retention yoke is designed to support span-wise and chord-wise forces acting on the at least one rotor blade.

In addition to one or more of the features described above, or as an alternative, in further embodiments comprising a tension torsion device extending between the radial arm and the retention yoke, wherein the tension torsion device supports all of the centrifugal forces acting on the at least one rotor blade.

In addition to one or more of the features described above, or as an alternative, in further embodiments at least one of the first bearing and the second bearing is a spherical pitch bearing including a plurality of rolling elements having a spherical outer diameter.

In addition to one or more of the features described above, or as an alternative, in further embodiments the radial arm includes a shaft-like protrusion connectable to the second bearing and a portion of the blade retention component includes a shaft-like protrusion connectable to the first bearing.

In addition to one or more of the features described above, or as an alternative, in further embodiments at least one of the shaft-like protrusion of the radial arm and the shaft-like protrusion of the inner blade retention component has a sleeve concentrically mounted thereto, the sleeve being slidable relative to the first bearing and/or the second bearing.

In addition to one or more of the features described above, or as an alternative, in further embodiments the rotor system is a main rotor system of an aircraft.

In addition to one or more of the features described above, or as an alternative, in further embodiments the rotor system is a tail propulsion system of an aircraft.

### BRIEF DESCRIPTION OF THE DRAWINGS

The subject matter which is regarded as the present disclosure is particularly pointed out and distinctly claimed in the claims at the conclusion of the specification. The foregoing and other features, and advantages of the present disclosure are apparent from the following detailed description taken in conjunction with the accompanying drawings in which:

FIG. 1 is a schematic diagram of an example of a rotary wing aircraft;

FIG. 2 is an exploded perspective view of a rotor hub and rotor blade according to an embodiment;

FIG. 3 is a exploded perspective view of the interface between the rotor hub and the rotor blade according to an embodiment;

FIG. 4 is a cross-sectional view of the blade retention assembly of the rotor hub according to an embodiment;

FIG. 5 is a cross-sectional view of the blade retention assembly according to an embodiment;

FIG. 6 is an exploded perspective view of the bearing interface between the radial arm and the outboard blade retention component according to an embodiment;

FIG. 7 is a exploded perspective view of the bearing interface between the radial arm and the outboard blade retention component according to an embodiment; and

FIG. 8 is a cross-sectional view of the bearing interface between the radial arm and the outboard blade retention component according to an embodiment.

### DETAILED DESCRIPTION

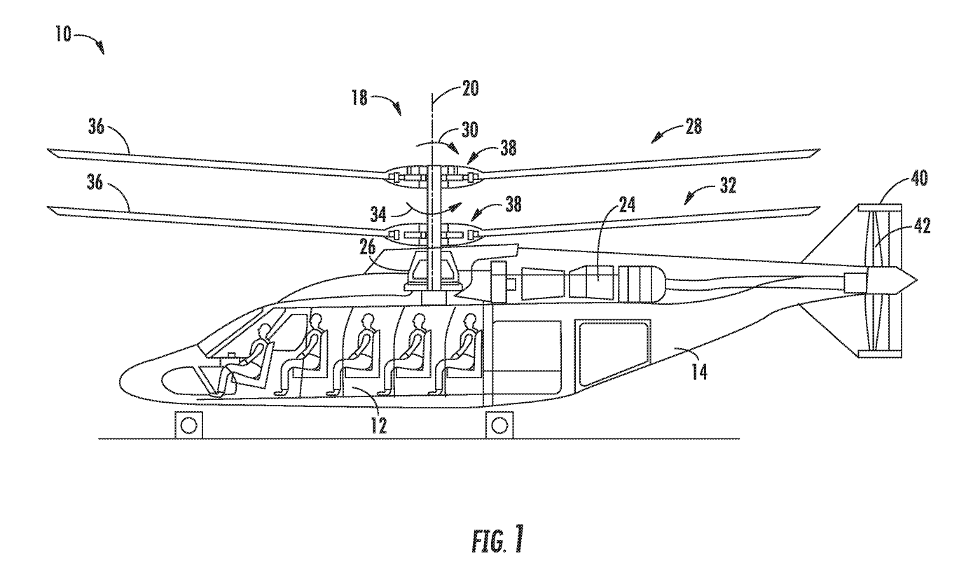

Referring now to FIG. 1, a schematic view of an example of a rotary wing aircraft, such as a helicopter for example, is illustrated. The rotary wing aircraft 10 includes an airframe 12 with an extending tail 14. A dual, contra-rotating coaxial main rotor assembly 8 is located at the airframe 12 and rotates about a main rotor axis 20. The main rotor assembly 18 is driven by a power source, for example, an engine 24 via a transmission 26. The main rotor assembly 18 includes an upper rotor assembly 28 driven in a first direction 30 about the main rotor axis 20, and a lower rotor assembly 32 driven in a second direction 34 about the main rotor axis 20, opposite to the first direction 30. While, in FIG. 1, the first direction 30 is illustrated as counter-clockwise and the second direction 34 is illustrated as clockwise, it is to be appreciated that in some embodiments the directions of rotation of the upper rotor assembly 28 and lower rotor assembly 32 may be reversed.

Each of the upper rotor assembly 28 and the lower rotor assembly 32 include a plurality of rotor blades 36 secured to a rotor hub 38. In some embodiments, the helicopter 10 further includes a translational thrust system 40 located at the extending tail 14 to provide translational thrust for the helicopter 10. The translational thrust system 40 includes a propeller rotor 42 connected to and driven by the engine 24 via the gearbox 26. While shown in the context of a pusher-prop configuration, it is understood that the propeller rotor 42 could also be more conventional puller prop or could be variably facing so as to provide yaw control in addition to or instead of translational thrust. Although a particular helicopter configuration is illustrated and described in the disclosed embodiment, other configurations and/or machines (e.g., other aircraft configurations) may be used in connection with this disclosure. For example, in some embodiments the aircraft may include a single rotor or tilt rotor system.

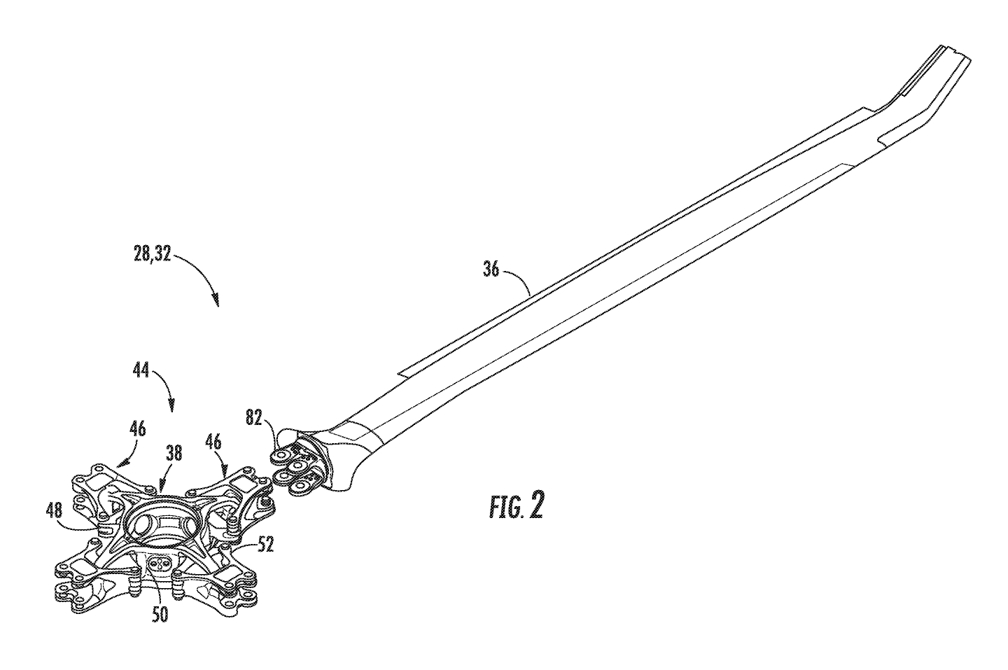

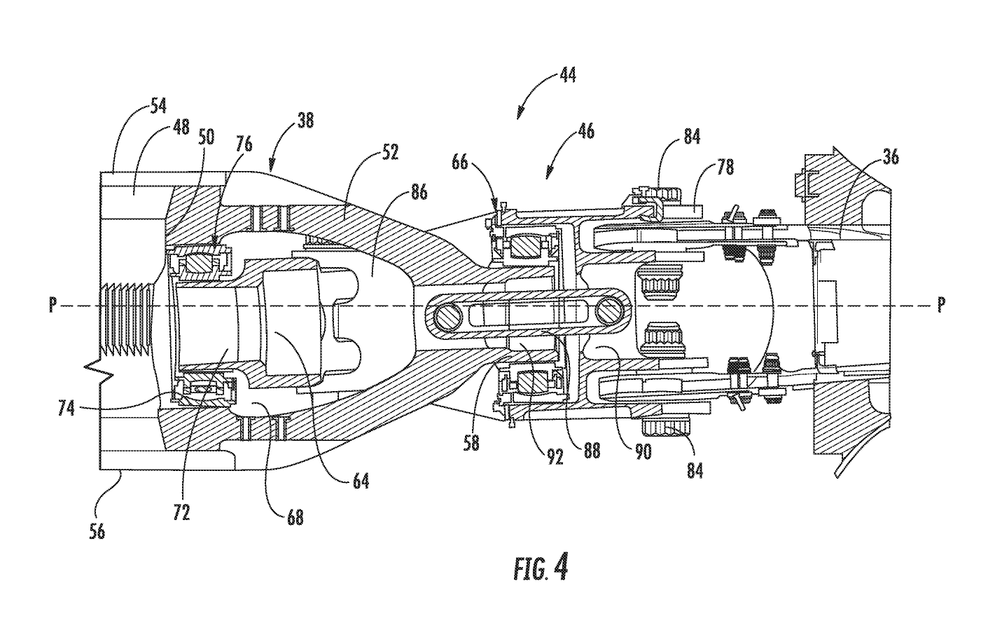

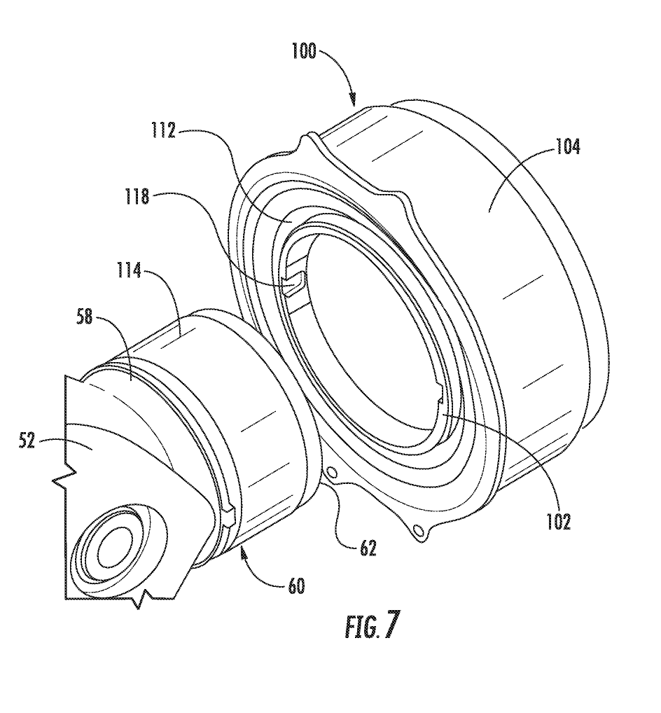

With reference now to FIGS. 2-8, each rotor assembly 28, 32 of the main rotor system includes a rotor head 44 having a rotor hub 38 and a plurality of blade retention yokes 46. The rotor hub 38 includes a central portion 48 having a substantially cylindrical exterior surface 50 and a plurality of arms 52 extending radially from the central portion 48 of the rotor huh 38. The radial arms 52 may be spaced equidistantly about the periphery of the rotor hub 38, as shown. Each of the radial arms 52 extends from both a first, upper surface 54 and a second, lower surface 56 of the rotor hub 38 and has a generally arcuate shape. In an embodiment, a shaft-like protrusion 58 extends outwardly from a portion of the radial arm 52. The shaft-like protrusion 58 is oriented generally perpendicular to the axis of rotation 20 of the rotor assembly 28, 32 and has a sleeve 60 concentrically mounted thereto. As shown, the sleeve 60 may be disposed adjacent the distal end 62 of the shaft-like protrusion 58.

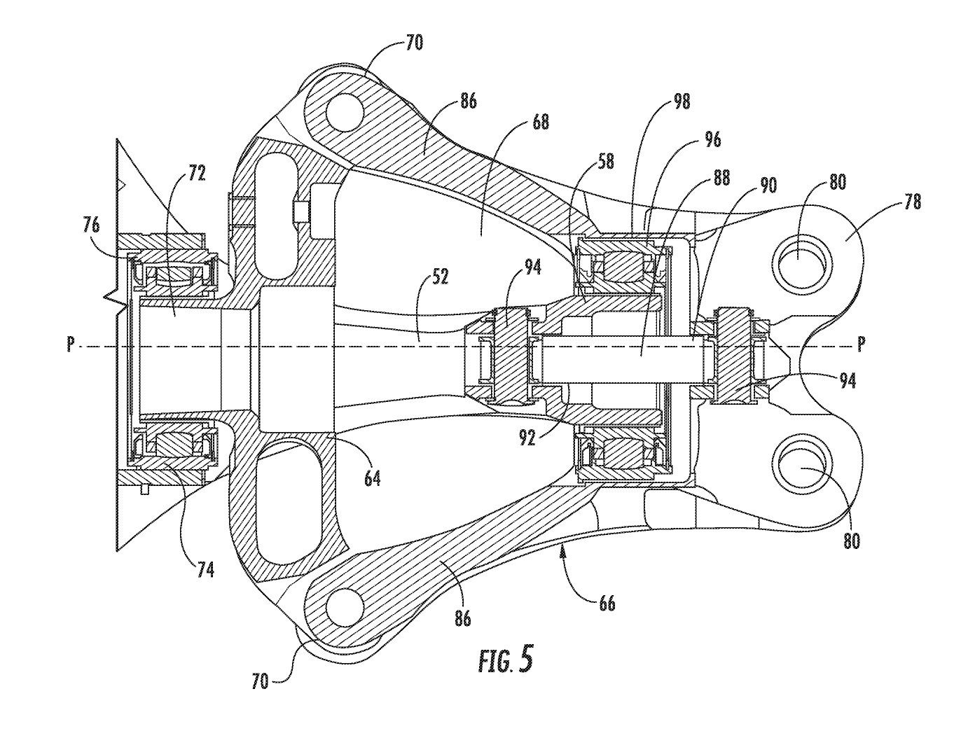

As previously described, the rotor head 44 includes a plurality of blade retention yokes 46 associated with the plurality of radial arms 52. Each blade retention yoke 46 includes a first inboard blade retention component 64 and a second, outboard blade retention component 66. The inboard blade retention component 64 is positioned within the opening 68 formed between the radial arm 52 and the exterior surface 50 of the rotor hub 38 such that arms or prongs 70 of the inboard blade retention component 64 are disposed on opposing sides of the radial arm 52 (best shown in FIG. 5). In an embodiment, the prongs 70 of the inboard blade retention component 64 extend at equal and opposing angles relative to the pitch axis P of the blade 36. However, embodiments where the prongs 70 are at any angle are contemplated herein. The inboard blade retention component 64 additionally includes a shaft-like protrusion 72 receivable within a corresponding opening 74 formed in the exterior surface 50 of the rotor hub 38. In an embodiment, a bearing 76 rotatably couples the shaft-like protrusion 72 of the inboard blade retention component 64 to the rotor hub 38.

The outboard blade retention unit 66 has a first end 78 configured to couple to a corresponding rotor blade 36. In the illustrated non-limiting embodiment, the first end 78 includes a plurality of holes 80 substantially identical to and configured to align with one or more holes 82 formed in a main rotor blade 36. Insertion of a pin or other fastener 84 through the holes 80, 82 of the outboard blade retention component 66 and the main rotor blade 36 restricts radial movement of the rotor blade 36 relative to the outboard blade retention component 66. However, any suitable mechanism for coupling the outboard blade retention component 66 and the rotor blade 36 is within the scope of the disclosure.

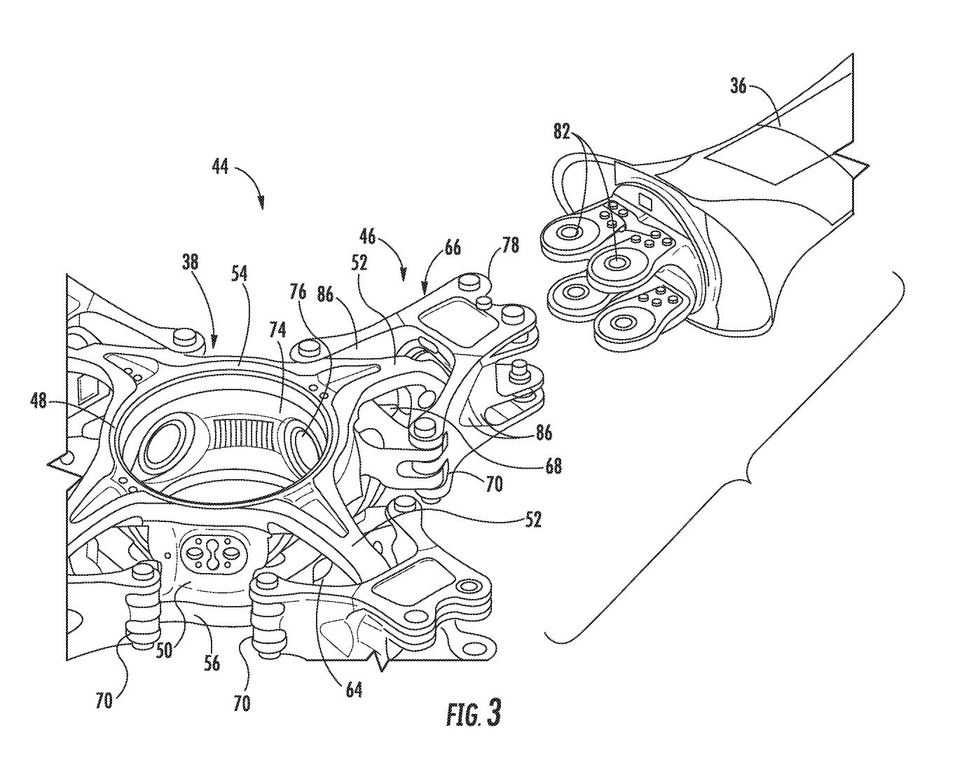

The outboard blade retention component 66 includes a pair of arms 86 and each arm 86 is configured to couple to a prong 70 of the inboard blade retention component 64, such as with one or more fasteners 87 for example. Accordingly, the interface between the inboard blade retention component 64 and the outboard blade retention component 66 substantially surrounds the sides of the radial arm 52, as best shown in FIGS. 3 and 5. A tension torsion device 88 is used to restrict radial movement of the outboard blade retention component 66 relative to the radial arm 52. In the illustrated, non-limiting embodiment, the tension torsion device 88 extends through an opening 90 formed in the outboard blade retention component 66 and an aligned opening 92 formed in the shaft-like protrusion 58 of the radial arm 52. The ends of the tension torsion device 88 may be affixed to an adjacent surface, such as with one or more fasteners 94 for example. The tension torsion device 88 is configured to support all of the centrifugal forces acting on the rotor blade 36.

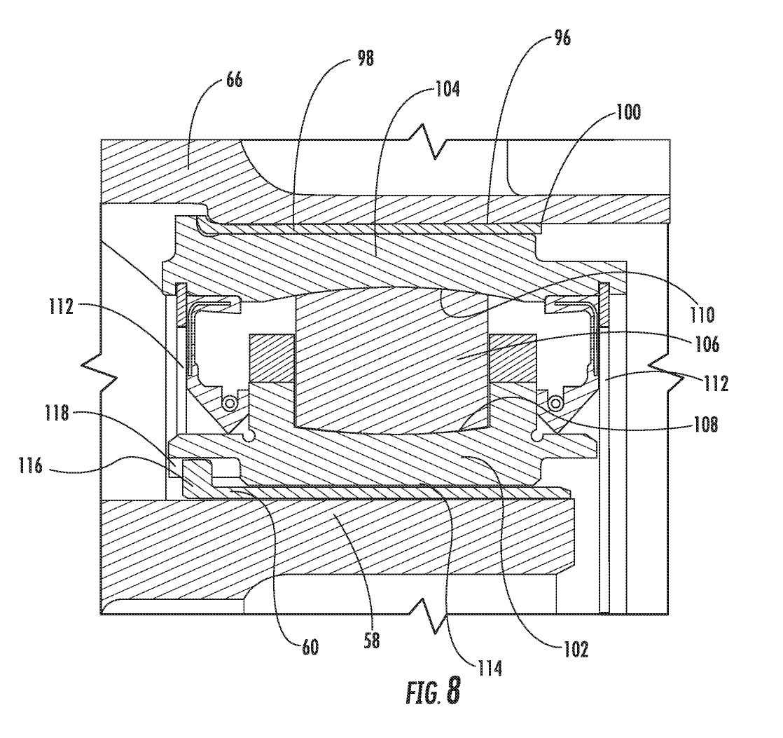

With reference to FIGS. 5-8, a bearing 100 is mounted within a cavity 96 formed in a central portion of the outboard blade retention component 66. As best shown in FIG. 8, an outer bearing liner 98 may be disposed between an outer surface of the bearing 100 and the adjacent surface of the outboard blade retention component 66. The bearing 100 generally includes an inner race 102, an outer race 104, and one or more rolling elements 106 disposed between the inner and outer races 102, 104 to allow rotational movement there between. In the illustrated, non-limiting embodiment, the rolling elements 106 have a circular outer diameter that is centered about the center of the bearing liner 98. As shown, the contour of the outer diameter of the rolling elements 106 is generally complementary to the inner surfaces 108, 110, respectively of both the inner race 102 and the outer race, upon which the rolling elements 106 are seated. Although only a single row of rolling elements 106 is shown in the FIGS., embodiments of bearing having multiple rows of rolling elements are also contemplated herein. A sealing component 112 may be mounted at one or both sides of the bearing 100 between the inner and outer races 102, 104, to retain lubricant associated with the rolling elements 106 within the interior of the bearing 100. The bearing 100 illustrated and described herein is intended as an example only, and any suitable bearing is considered within the scope of the disclosure.

In the illustrated, non-limiting embodiment, the bearing 76 associated with the shaft-like protrusion 72 of the inboard blade retention component 64 has a substantially identical configuration to the bearing 100. However, embodiments where the bearings 76, 100 are different sizes, such as the outer diameter and/or inner diameter of the hearings 76, 100 for example, and/or different configurations are also contemplated herein.

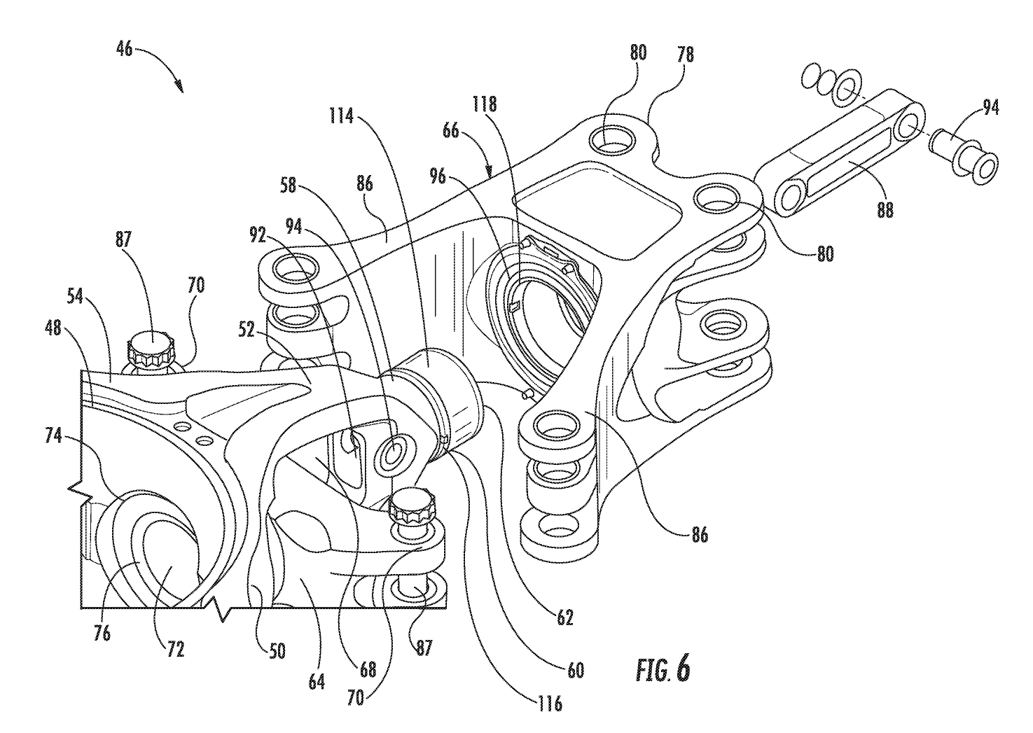

In the illustrated, non-limiting embodiment, the sleeve 60 coupled to the shaft-like protrusion 58 includes a low friction material 114, such as Teflon for example. When the radial arm 52 is coupled to the outer blade retention component 66, the sleeve is received within the bore of the inner race of bearing 100. Inclusion of the low-friction material 114 allows for relative motion between the radial arm 52 and the outer blade retention component 66. In another embodiment, the sleeve 60 mounted to the shaft-like protrusion 58 may function as the inner race 102 of the bearing 100. It should be understood that the shaft-like protrusion 72 of the inner blade retention component 64 may similarly include a sleeve having a low friction material or operable as the inner race of the bearing 76. As best shown in FIG. 6, in an embodiment, one or more features 116, such as keys for example, protrude from the surface of the sleeve 60. The features 116 are adapted for receipt within a corresponding opening or keyway 118 formed in the inner race 102 of the bearing 100. The features and the keyways 118 are generally complementary in size and shape such that engagement of the features 116 within the keyways 118 couples the sleeve 60, and therefore the shaft-like protrusion 58 to the inner race 102 of the bearing 100.

By using one or more hearings 76, 100 having a plurality of at least partially circular rolling elements 106, one or more bearings 76, 100 are able to provide a low torsional resistance to rotation of the rotor blade about the pitch axis P. Further the bearings 76, 100 are able to accommodate the span-wise and chord-wise forces of the rotor blade 36 and the resultant deflection of the rotor hub 38. The bearings 76, 100 allow relative motion between adjacent components of the structure connecting the rotor blade 36 to the rotor head 44. By supporting the rotor blade 36 in such a manner, i.e. the combination of hearings 76, 100 and the tension torsion device 88, any windup of the tension torsion device 88 due to rotation of the rotor blade 36 about the pitch axis P will not be transferred to the bearings 76, 100. Accordingly, the design of the rotor head 44 provides a weight optimized blade support system that can withstand the forces and deflection of a rotor blade. Further, the system illustrated and described herein may be adapted for use with both folding and non-folding rotor blades 36.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions or equivalent arrangements not heretofore described, but which are commensurate with the spirit and scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What is claimed is:

1. A blade retention system comprising:
a rotor hub including a plurality of radial arms;
a blade retention yoke associated with the rotor hub and one of the plurality of radial arms, the blade retention yoke being rotatable relative to the rotor hub and the radial arm;
a tension torsion device connecting the radial arm to the blade retention yoke to restrict radial movement of the blade retention yoke relative to the radial arm.

2. The blade retention system of claim 1, wherein the blade retention yoke is rotatable relative to the rotor hub and the radial arm via at least one bearing.

3. The blade retention system of claim 2, wherein the blade retention yoke includes an inner blade retention component and an outer blade retention component, the inner blade retention component being connected to the rotor hub via a first bearing and the outer blade retention component being connected to the radial arm via a second bearing.

4. The blade retention system of claim 2, wherein the blade retention yoke is mountable to a rotor blade, and the first bearing and the second bearing are configured to accommodate span-wise and chord-wise forces acting on the rotor blade which allow rotation about a pitch axis of the rotor blade.

5. The blade retention system of claim 4, wherein the tension torsion device, and not the first bearing or second bearing, supports the centrifugal forces acting on the rotor blade which is substantially parallel to the pitch axis.

6. The blade retention system of claim 3, wherein the radial arm includes a shaft-like protrusion connectable to the second bearing and the inner blade retention component includes a shaft-like protrusion connectable to the first bearing.

7. The blade retention system of claim 6, wherein at least one of the shaft-like protrusion of the radial arm and the shaft-like protrusion of the inner blade retention component has a sleeve concentrically mounted thereto.

8. The blade retention system of claim 7, wherein the sleeve includes a low friction material such that the sleeve is slidable relative to the first bearing and/or second bearing.

9. The blade retention system of claim 7, wherein the sleeve includes at least one feature receivable within a corresponding opening formed in the first bearing or second bearing to rotatably couple the shaft-like protrusion to the first bearing and/or second bearing.

10. The blade retention system of claim 7, wherein the sleeve defines an inner race of the first bearing and/or second bearing.

11. The blade retention system of claim 3, wherein at least one of the first bearing and the second bearing further includes:
an inner race;
an outer race;
a plurality of rolling elements positioned between the inner race and the outer race, the plurality of rolling elements having a spherical outer diameter; and
a bearing liner is positioned between the outer race and the outer blade retention component, wherein the plurality of rolling elements are centered about a center of the bearing liner.

12. A rotor system comprising:
a rotor hub including at least one radial arm;
at least one rotor blade;
at least one blade retention yoke connecting the at least one rotor blade to the rotor hub and the at least one radial arm;
a first bearing mounted at an interface between the blade retention yoke and the rotor hub; and
a second bearing mounted at an interface between the blade retention yoke and the radial arm, wherein the blade retention yoke is designed to support span-wise and chord-wise forces acting on the at least one rotor blade.

13. The rotor system of claim 12, further comprising a tension torsion device extending between the radial arm and the retention yoke, wherein the tension torsion device supports all of the centrifugal forces acting on the at least one rotor blade.

14. The rotor system of claim 14, wherein at least one of the first bearing and the second bearing is a spherical pitch bearing including a plurality of rolling elements having a spherical outer diameter.

15. The rotor system of claim 12, wherein the radial arm includes a shaft-like protrusion connectable to the second bearing and a portion of the blade retention component includes a shaft-like protrusion connectable to the first bearing.

16. The blade retention system of claim 15, wherein at least one of the shaft-like protrusion of the radial arm and the shaft-like protrusion of the inner blade retention component has a sleeve concentrically mounted thereto, the sleeve being slidable relative to the first bearing and/or the second bearing.

17. The rotor system of claim 12, wherein the rotor system is a main rotor system of an aircraft.

18. The rotor system of claim 12, wherein the rotor system is a tail propulsion system of an aircraft.
